(19) United States
(12) Patent Application Publication
(10) Pub. No.: US 2020/0341449 A1
(43) Pub. Date: Oct. 29, 2020

(54) System and Method for Managing a System Configuration of a Robot Controller

(71) Applicant: ABB Schweiz AG, Baden (CH)

(72) Inventors: Elina Vartiainen, Västerås (SE); Jonas Brönmark, Västerås (SE); Roger Kulläng, Västerås (SE); Olov Nylen, Västerås (SE); Goran Mustapic, Västerås (SE); Kjell Svensson-Landin, Västerås (SE); Mats Kapanen, Eskilstuna (SE)

(21) Appl. No.: 16/760,153

(22) PCT Filed: Dec. 22, 2017
(86) PCT No.: PCT/EP2017/084460

§ 371 Date: Apr. 29, 2020

(51) Int. Cl. G05B 19/409; G05B 19/414

(52) U.S. Cl. CPC G05B 19/409; G05B 19/4147; G05B 2219/25064; G05B 2219/40099; G05B 2219/25067

(57) ABSTRACT

An area of robotic control, and in particular to managing a system configuration of a robot controller. According to a first aspect, the disclosure relates to a method for managing a system configuration of a robot controller configured to control operation of a robot. The method includes capturing S1 a snapshot of the robot controller, the snapshot including a current system configuration of the robot controller and storing S2 the captured snapshot in the backup archive. The method further includes generating S3, on the display representing one or more snapshots stored in the backup archive presented in chronological order and upon receiving S4, from the input device, user input selecting one of the displayed elements, retrieving S5, from the backup archive information corresponding to the snapshot represented by the selected element, and providing S6 the retrieved system configuration. The method also relates to a corresponding control system.

### TECHNICAL FIELD

The present disclosure relates to the area of robotic control, and in particular to managing a system configuration of a robot controller.

### BACKGROUND

Robots have historically been used in industry for performing repetitive tasks. A robot controller is the “brain” of a robot, it executes application code and commands the robot to move accordingly. Just as with regular desktop PCs, robot controllers need software updates to, for example, improve functionality, performance optimizations, bug fixes and eliminate potential security problems.

However, these updates sometimes introduce unexpected behavior and problems with the robot or the robot controller. This causes users of robots (i.e. robot operators) to be very cautious of any software changes to robot controllers as an unexpected software glitch may risk causing expensive production downtime.

To minimize the possibility of downtime, users of industrial robots sometimes have multiple versions of robot controller software installed. If an installed robot controller software fails, they can roll back to a previously tested robot controller software. To support this robot controllers often include a backup functionality, which enables creating a backup copy of user data, such as configuration data or programs added by a user. However, to roll back, the user needs to know which files and parameters to restore from previous versions. The user also needs to know which version to use for the different files and parameters. Thus, the user needs to have a deep understanding of the robot controller and its software, making this solution available only for expert users. Hence, there is a need for improved ways to perform reliable and easy switch between robot controller software versions.

### SUMMARY

It is thus an object of the disclosure to alleviate at least some of the drawbacks with the prior art. It is an object to provide a solution for robot controllers that allows users to test and experiment with robot controller software, and in case of unexpected robot behaviors or software glitches easily roll back to a previously used system configuration. This object and others are at least partly achieved by the method and the control system according to the independent claims, and by the embodiments according to the dependent claims.

According to a first aspect, the disclosure relates to a method for managing a system configuration of a robot controller configured to control operation of a robot. The method comprises capturing a snapshot of the robot controller and storing the captured snapshot in the backup archive. The snapshot comprises a current system configuration of the robot controller. The method further comprises generating, on a display, a graphical user interface including elements representing one or more snapshots stored in the backup archive presented in chronological order and upon receiving, from an input device, user input selecting one of the displayed elements, retrieving, from the backup archive information corresponding to the snapshot represented by the selected element, and providing the retrieved system configuration.

By letting elements in a graphical user interface illustrate available backup versions, a user-friendly user interface for backing up a robot controller is provided. Since a snapshot includes both the same type of user data as a traditional backup and in addition manufacturer software and configuration data, the user can quickly come back to where snapshot was taken, without knowledge about the software version. Thus, users who previously did not dare to edit the software running on the robot controllers now have the possibility to experiment more and in case something goes wrong they simply roll back to a previous system configuration or state. Furthermore, users who previously did not manage to work with multiple robot controller software due to complexity now have the possibility to do so.

According to some embodiments the method comprises installing an initial system configuration and storing a snapshot comprising the initial system configuration in the backup archive. Thereby, a user may via a simple user interface input return to the initial version of the robot controller.

According to some embodiments the method comprises repeating the capturing and the storing upon reception of user input, in response to predefined triggers and/or on a periodical basis. Thus, system reliability is increased as snapshots may be captured and stored without the user being aware of it. Alternatively, the user may select to make a backup before making changes that would potentially introduce software problems.

According to some embodiments the method comprises capturing and storing snapshots representing distinct systems of a multiple system configuration of the robot. Hence, the proposed method might replace a traditional multiple system configuration.

According to some embodiments the method comprises displaying the elements along a timeline. A timeline representation is a perceivable way of presenting the available snapshots.

According to some embodiments the snapshot comprises a snapshot identifier and then the generating comprises displaying the snapshot identifier in connection with the corresponding displayed element. Thereby, the user might e.g. name the versions in order to keep track of e.g. a milestone in an ongoing project.

According to some embodiments the generating comprises displaying elements representing snapshots captured during a limited time period and moving the limited time period forwards or backwards in time in response to receiving a user input indicating scrolling. Thereby, the user may easily view and select all available snapshots.

According to some embodiments the providing comprises installing the retrieved system configuration in the robot controller. Thus, a user may easily revert to a previous robot controller configuration.

According to some embodiments the providing comprises loading the retrieved system configuration on a data storage device, sending the retrieved system configuration to another robot controller and/or sending the retrieved system configuration to a remote device. Thereby, users with several robot controllers can utilize the possibility to back up a snapshot from one robot controller and then import the snapshot to one or more of or all the other robot controllers.

According to some embodiments, the providing comprises presenting, in the graphical user interface, selectable elements representing provision alternatives. Thus, a user may easily select whether to re-install the selected snapshot or whether to use it in another robot controller.

According to some embodiments, the storing comprises storing the snapshot in a backup archive being a backup archive in the robot controller and/or in backup archive external to the robot controller. Using an external backup archive may be beneficial if the internal memory of the robot controller is limited. When using an external data storage for the backup archive, there is basically no limit in the number of snapshots that can be stored.

According to some embodiments the receiving comprises receiving a touch input, a cursor input command, a voice command, a sight command or a gesture command at the graphical user interface. In principle, the use of a graphical user interface makes it possible to use all available input alternatives.

According to a second aspect, the disclosure relates to a control system configured to manage a system configuration of a robot controller of a robot. The control system is configured to be connected to or to access a display and an input device and is also provided with access to a backup archive. The control system comprises one or more computing devices having at least one processor and memory. The at least one computing device is configured to generate on the display, a graphical user interface including elements representing one or more snapshots stored in the backup archive presented in chronological order and upon receiving, from the input device, user input selecting one of the displayed elements, retrieve, from the backup archive information corresponding to the snapshot represented by the selected element, and to provide the retrieved system configuration.

According to some embodiments the at least one computing device is configured to repeatedly capture and store snapshots upon reception of user input, in response to predefined triggers and/or on a periodical basis.

According to some embodiments the at least one computing devices is configured to display the elements along a timeline.

According to some embodiments the at least one computing devices is configured to display elements representing snapshots captured during a limited time period and moving the limited time period forwards or backwards in time in response to receiving a user input indicating scrolling.

According to a third aspect, the disclosure relates to a robot, a display configured to display robot control information, an input device configured to receive user input from a user, a backup archive and the control system.

According to a fourth aspect, the disclosure relates to a computer program comprising instructions which, when the program is executed by a control system, cause the control system to carry out the method as described herein.

According to a fifth aspect, the disclosure relates to a computer-readable medium comprising instructions which, when executed by a control system, cause the control system to carry out the method as described herein.

### BRIEF DESCRIPTION OF THE DRAWINGS

FIG. 1 illustrates a robot controlled by a robot controller.

FIG. 2 illustrates an example implementation of a robot controller user interface comprising snapshots presented along a timeline.

FIG. 3 illustrates the proposed method for managing a robot controller.

FIG. 4 illustrates the timeline of FIG. 2 as a user scrolls back to view older snapshots.

FIG. 5 illustrates an example implementation of a user interface for viewing details of a snapshot and to activate the snapshot.

### DETAILED DESCRIPTION

This disclosure proposes to create a “timeline” representation of a robot controller configuration that allows users to easily switch between controller software versions. The basic idea is to capture snapshots of the robot controller configuration and to represent the snapshots on the timeline in a graphical user interface, such that a user can easily access the snapshots without any specific knowledge about the robot controller software. The snapshot may typically contain all information necessary to bring the system configuration back to the state when the snapshot was taken.

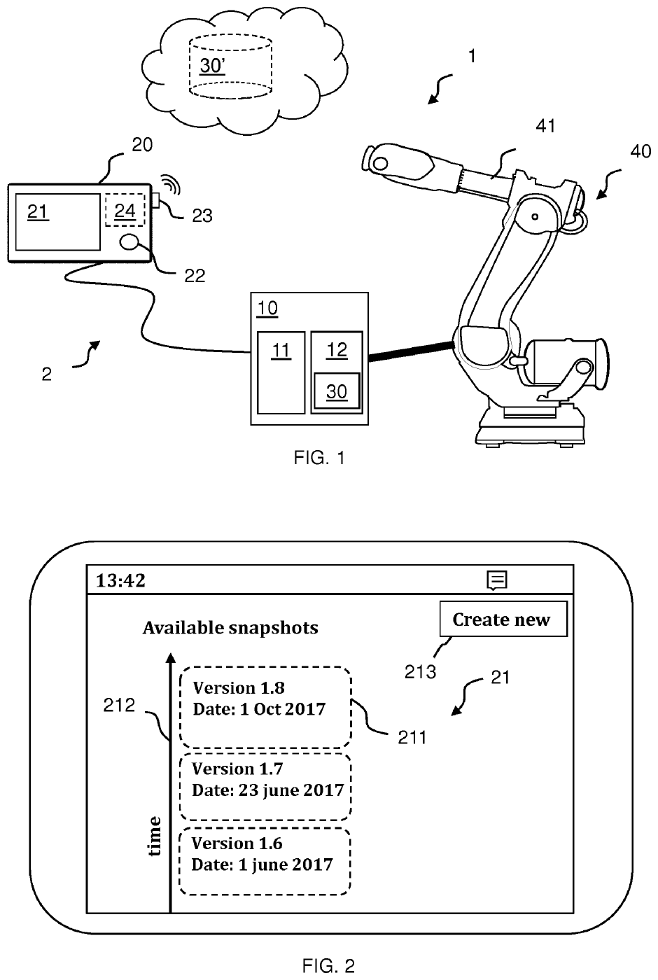

FIG. 1 shows an industrial robot system 1 where the proposed technique may be implemented. The industrial robot system 1 comprises a robot controller 10, a user interface device 20 in communication with the robot controller 10, an external backup archive 30′, and a robot 40.

In FIG. 1, the robot 40 is an industrial robot comprising one robot arm 41. However, the proposed technique may be used for any movable mechanical unit. In operation, a tool is typically attached to the outer of the robot arm 41. The robot arm 41 comprises one or more motion mechanisms adapted to set the robot arm in motion. Each motion mechanism typically comprises a motor unit and a brake unit (not shown). The robot controller 10 controls the operation of the robot 40 by means of controlling the speeds of the motion mechanisms.

The robot controller 10 typically comprises one, or several, processors 11 and memories 12. The processor 11 may be a processor module such a CPU (Central Processing Unit) or a microcontroller. The memory 12 may comprise a non-volatile memory and/or a removable memory such as a USB (Universal Series Bus) memory stick. The robot controller 10 also comprises appropriate I/O interfaces for handling communication e.g. with the robot 40, the user interface device 20 and/or the backup archive 30′.

The user interface device 20 is a device that enables a user to control the robot controller 10. The user interface device 20 is connected to the robot controller 10, either wirelessly or by wire. In FIG. 1 the user interface device 20 is a teach pendant. A teach pendant is a handheld control panel that a user may use to guide a robot through the steps required to complete a task. However, the user interface device 20 may as well be an ordinary computer or similar.

The user interface device 20 comprises a processor 24, memory (not shown), a display 21 and an input device 22, such as a joystick, physical buttons, or touch buttons. Even more advanced input techniques may be used, such as voice recognition or gaze detection. The software executed by the processor 24 needs to be compatible with the software running in the robot controller 10. It may e.g. be downloaded from the robot controller 10 at installation. The user interface device 20 may also comprise an internal user interface program configured to cause the processor 24 to create a graphical user interface and to display the user interface on the display 21. Such an embodiment might keep down the communication between the robot controller 10 and the user interface device 20, which might be desirable for time critical applications. According to some embodiment the user interface device 20 comprises a communication interface 23, such as a wireless communication interface for communication with external devices or a USB port.

The proposed technique relates to storing backup data of a robot controller 10. Such backup data may in principle be stored in any data storage that the robot controller 10 may access. The data structure used for storing backup data is herein referred to as a backup archive. In some example embodiments herein, the backup archive is stored in an internal backup archive 30 stored in the memory 22 of the robot controller 10. The backup archive may also be an external backup archive 30′ such as in a cloud implemented database. Internal and external storage may also be used in combination in a suitable manner, where e.g. older backup versions are moved from the internal backup archive 30 to the external archive 30′. It is also possible to store the backup archive (at least partly) in the user interface device 20.

FIG. 2 illustrates an example of a graphical interface that is displayed on the display 21 when using the proposed technique. The graphical user interface of FIG. 2 comprises elements 211 representing snapshots of the robot controller 10 presented along a timeline 212. Thus, the “timeline” is a visual representation of snapshots of the robot controller configuration. On the display 21 it is easy to see a number of available snapshots and descriptions of each.

The user can scroll the list of available snapshots and activate one, which then becomes the current configuration. The snapshots may cover both software provided by the robot manufacturer in the form of software updates, as well as other file changes such as user modification in the program controlling the robot path or configuration of other parts of the robot controller's software system. The use of a “timeline” representation makes it very easy for users to manage all available snapshots, save new snapshots and restore the system configuration to a previously saved snapshot. For example, the “timeline” makes it very easy to e.g. scroll the timeline to find and restore an older system configuration.

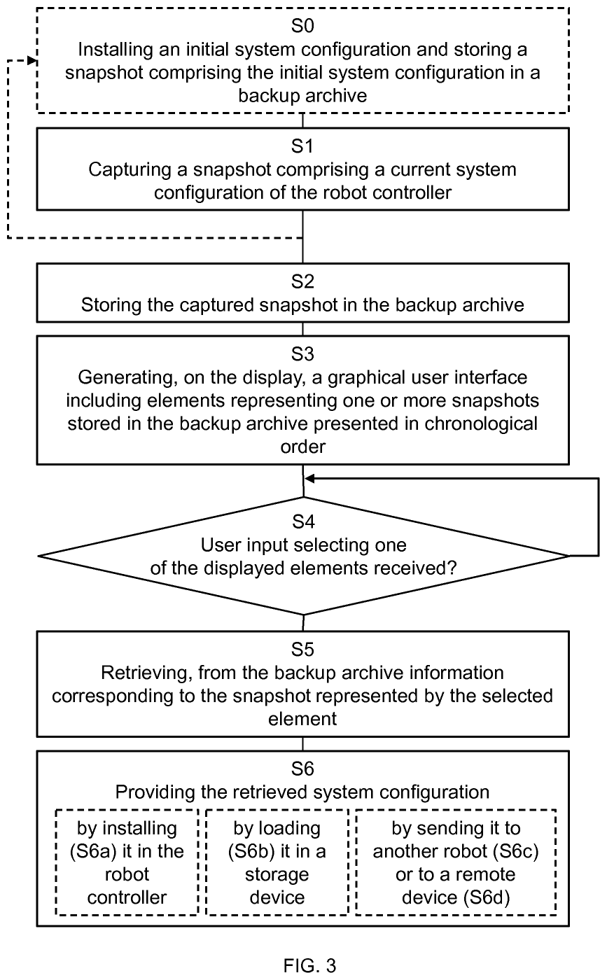

The proposed technique of managing a system configuration robot controller 10 will now be described in further detail with reference to the flowchart of FIG. 3 and to the other figures.

FIG. 3 illustrates the proposed method for managing a system configuration of a robot controller. The method is either performed during normal operation of the robot 1 or during development and/or service. The method is typically implemented in a control system 2 of the robot. In this example the method is implemented in the robot controller 10 itself. However, the software of the robot controller 10 and the user interface device 20 are often tightly integrated. Thus, some parts of the method are in some embodiments executed by the user interface device 20.

The steps of the method may be defined in a computer program, comprising instructions which, when the program is executed by processors (e.g. processor 11 of the robot controller and processor 24 of the user interface device 20) of the control system 2, causes the control system 2 to carry out the method. The steps of the method may also be defined in a computer-readable medium, e.g. an internal memory 12 of the robot controller 10 and/or in any other memory. The computer-readable medium comprises instructions that, when executed by a control system 2, causes the control system 2 to carry out the method.

When the robot is put into use the first time an initial system configuration is loaded in the robot controller 10. It is typically desirable to save this initial system configuration in the backup archive 30, 30′. Thus, according to some embodiments, the method comprises installing SO an initial system configuration and storing a snapshot comprising the initial system configuration in the backup archive 30, 30′.

Before operation is started, the robot 40 is typically calibrated. During calibration, calibration parameters are stored in the memory 12 of the robot controller 10. The robot 40 is then put into use. During operation, the user might want to update the software or other parameters in the robot controller. The proposed method may be used to restore previous settings used during calibrations or operation.

The method comprises capturing 51 a snapshot of the robot controller 10. The snapshot comprises a current system configuration of the robot controller 10. According to some embodiments the snapshot also comprises information defining a capturing time. A capturing time is e.g. a time stamp defining when the snapshot was captured. A snapshot is a read-only copy of the current state of the robot controller 10. In other words, the memory 12 of the robot controller 10 that is storing the present software and/or state of the robot 40 is copied. The snapshot may for example comprise processes, threads, modules, and heaps. More generally the system configuration for example comprises at least one of operating system software, application software, user data, robot calibration data and/or robot configuration data.

In other words, in addition to user data that traditionally is included in a backup, a snapshot also comprises manufacturer data, including robot controller software and other data generated by the manufacturer. The manufacturer data may be software and/or data generated by the robot controller during operation of the robot. When reloading the robot controller from a traditional backup, the user normally needs to know which software version that was running when the backup was made for the backup to be correctly restored. Since a snapshot includes both the user data of a traditional backup and in addition manufacturer software and configuration data, the user can quickly come back to where snapshot was taken, without knowledge about the software version.

The method then comprises storing S2 the captured snapshot in the backup archive 30, 30′ configured to store a plurality of snapshots of the robot controller. In other words, the copied memory, and typically also a capturing time, is stored so that it can be reloaded at a later point in time. Other parameters may also be stored in or in relation to the snapshot. For example, each snapshot may be associated with an identifier, such as a number, a name or a string. In some embodiments, the user might be given the opportunity to give each snapshot a name.

The snapshot may either be stored in a backup archive 30, 30′ being an internal backup archive 30 in the robot controller 10. In addition, or alternatively, the snapshot may be stored in an external backup archive 30′ external to the robot controller. For example, the snapshot may be sent to an external backup archive using e.g. the communication interface 23 of the user interface device 20.

The capturing 1 and the storing S2 are typically performed several times as indicated by the dashed arrow back to step S1 in FIG. 3. More specifically, according to some embodiments, the capturing S1 and the storing S2 are repeated upon reception of user input, in response to predefined triggers and/or on a periodical basis. For example, a user may press an element 213 (FIG. 2), when a snapshot should be captured and stored. Predefined triggers that may initiate the capturing S1 and the storing S2 are software updates or other changes. For example, a snapshot is always generated before a new software version is installed. Snapshots may also be captured and stored on a periodical basis, such as every night.

Today robots are sometimes operated in a so called multiple system configuration. This implies that the industrial robots have multiple versions of robot controller software installed. The reason might be the desire to perform different tasks or to just have a backup system if one system fails. The captured and stored snapshots may represent distinct systems of a multiple system configuration of the robot 40. Thereby, it is not needed to install several copies of the system, as the snapshots would enable shifting the entire system including states, parameters and settings.

At some point in time the user of the robot 40 might want to revert to system configuration. This might e.g. be due that that a recent software update has introduced problems. Alternatively, the user might want to operate in another system, e.g. a system corresponding to another task, of a multi system configuration. The user may then, via a graphical user interface presented on the display 21, get information about previously captured snapshots that can be accessed from the backup archive. The graphical user interface may for example be accessed via a menu or by a special input command.

Thus, the method further comprises generating S3, on the display 21, a graphical user interface including elements 211 representing one or more snapshots stored in the backup archive 30, 30′ presented in chronological order. If the user interface device 20 has an internal user interface program, then the generating S3 is typically performed by the user interface device 20. In the graphical user interface, the elements are e.g. presented along a timeline 212.

If a snapshot is associated with snapshot identifier, then the identifier may also be presented to the user. In other words, then the generating also comprises S3 displaying the snapshot identifier in connection with the corresponding displayed element 211.

The backup functionality i.e. the storing and capturing may be performed during a long period of time. Thus, the backup archive 30, 30′ may comprise many more snapshots than can be shown on the screen. In such a scenario, only elements 211 representing snapshots captured during a limited time period will be displayed on the screen. That is, only a certain number of elements are displayed. For example, the most recent snapshots are illustrated. The user may then move back in time, e.g. by scrolling along the timeline. In other words, the limited time period is moved forwards or backwards in time in response to receiving a user input indicating scrolling.

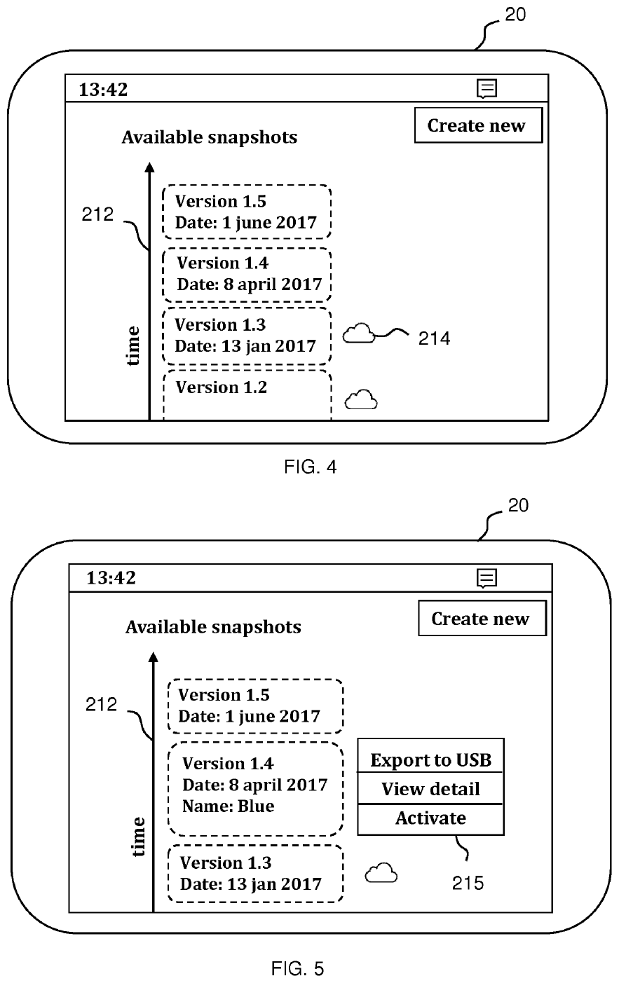

FIG. 4 illustrates the graphical user interface of FIG. 2 where the user has scrolled the timeline to view older snapshots. In this example, the older snapshots (version 1.2 and 1.3) are stored in an external backup archive, which is illustrated by the cloud symbol 214.

The user may then select the snapshot that he or she wants to use by e.g. touching on it or by clicking on it or by any other suitable user input means mentioned in connection with FIG. 1. When a user input is provided via the user input device 22, it will be detected and received S4, e.g. by the processor 24 of the user interface device 20. User input selecting one of the displayed elements 211, is e.g. a touch input, a cursor input command, a voice command, a sight command or a gesture command at the graphical user interface.

The method further comprises, upon receiving S4 the user input, retrieving S5, from the backup archive 30, 30′ information corresponding to the snapshot represented by the selected element, and providing S6 the retrieved system configuration. The providing implies that the retrieved system configuration is used, or made available for use, by the user. There are several different ways to do this.

One possibility is that the user wishes to revert to the retrieved system configuration. Thus, in some embodiments the providing S6 comprises installing S6a the retrieved system configuration in the robot controller.

The “timeline” typically builds forward and never goes back in time, which means that when the user activates an earlier snapshot of the system configuration, the earlier snapshot is copied and installed to replace the current system configuration of the robot controller 10. If a new snapshot is captured in connection with installation of the retrieved system configuration, a new snapshot (identical to the old version) will be added at the top of the timeline. In this way there is only one timeline presentation for the snapshots without any additional branches.

Alternatively, the user might want to use the retrieved system configuration in another robot. This might e.g. be done by loading the retrieved system configuration on a USB stick and loading it into another robot controller. Thus, according to some embodiments, the providing comprises loading S6b the retrieved system configuration on a data storage device.

Alternatively, the other robot controller might be accessed directly, e.g. via a wireless interface. Thus, according to some embodiments, the providing comprises sending S6c the retrieved system configuration to another robot controller.

It might also be desired to store the retrieved system configuration in some other device for later use e.g. in a server. Thus, according to some embodiments, the providing comprises sending S6d the retrieved system configuration to a remote device.

It should be easy for the user to use previously retrieved snapshots. For example, different options could be presented at the graphical user interface. FIG. 5 illustrates an example implementation of a user interface where a user may select how to use a selected snapshot. Typically, the user has selected one of the snapshots, then several useful options 215 are presented such as to “activate the snapshot”, or to “save the snapshot to a USB drive”, this would make it easy to move snapshots between robot controllers. In other words, according to some embodiments, the providing comprises presenting, in the graphical user interface, selectable elements 215 representing provision alternatives. As already mentioned above, the snapshots can be saved to the disk of the robot controller 10 or to the cloud (in order to save disk space). In both cases, the user is able to activate the snapshot in a similar way by selecting it in the timeline.

The disclosure also relates to a corresponding control system 2 (FIG. 2) configured to execute the method of FIG. 3. The control system 2 may comprise one or several computing devices including at least one processor and memory, such as the robot controller 10 itself, the user interface device 20 and/or a cloud implemented computing device. In general, a software system for implementing the proposed technique may be structured in different ways, while still achieving the same effects and user experience.

In general, the control system 2 is configured to perform all embodiments of the method described herein. This might e.g. be achieved by executing software stored in the memory of the one or more computing devices that causes the control system 2 to perform the method. In one example implementation, the user interface device 20 is configured to perform the parts of the method (step S3 and S4 of FIG. 3) related to generating and receiving input from the graphical user interface and the robot controller 10 is configured to perform the other parts of the method.

Furthermore, the robot control system 2 is configured to be connected to or to access a display and an input device, such as the display 21 and user input device 22 of the user interface device 20. In other words, the control system 2 is arranged to provide a user interface on a display and to receive user input from a user input device to which it is connected or has access. The control system is further provided with access to a backup archive e.g. internal backup archive 30 or external backup archive 30′.

More specifically, the control system 2 is configured to capture a snapshot comprising a current system configuration of the robot controller and store the captured snapshot in a backup archive. The control system 2 is further configured to generate on the display, a graphical user interface including elements representing one or more snapshots stored in the backup archive presented in chronological order and upon receiving, from the input device, user input selecting one of the displayed elements, retrieve, from the backup archive information corresponding to the snapshot represented by the selected element, and provide the retrieved system configuration.

According to some embodiments the control system 2 is configured to install an initial system configuration and to store a snapshot comprising the initial system configuration in the backup archive.

According to some embodiments the control system 2 is configured to repeatedly capture and store snapshots upon reception of user input, in response to predefined triggers and/or on a periodical basis.

According to some embodiments the control system 2 is configured to capture and store snapshots representing distinct systems of a multiple system configuration of the robot.

According to some embodiments the control system 2 is configured to display the elements along a timeline.

According to some embodiments the control system 2 is configured to display elements representing snapshots captured during a limited time period and moving the limited time period forwards or backwards in time in response to receiving a user input indicating scrolling.

According to some embodiments the control system 2 is configured to provide the retrieved system configuration by installing the retrieved system configuration in the robot controller. According to some embodiments the control system 2 is configured to provide the retrieved system configuration by loading the retrieved system configuration on a data storage device. According to some embodiments the control system 2 is configured to provide the retrieved system configuration by sending the retrieved system configuration to another robot controller. According to some embodiments the control system 2 is configured to provide the retrieved system configuration by sending the retrieved system configuration to a remote device.

According to some embodiments the control system 2 is configured to provide the retrieved system configuration by the control system 2 is configured to present, in the graphical user interface, selectable elements representing provision alternatives.

According to some embodiments the control system 2 is configured to provide the retrieved system configuration by the control system 2 is configured to store the snapshot in a backup archive being a backup archive in the robot controller and/or in backup archive external to the robot controller.

According to some embodiments the system configuration comprises at least one of operating system software, application software, user data, robot calibration data and/or robot configuration data.

According to some embodiments the control system 2 is configured to receive a touch input, a cursor input command, a voice command, a sight command or a gesture command at the graphical user interface.

The present invention is not limited to the above-described preferred embodiments. Various alternatives, modifications and equivalents may be used. Therefore, the above embodiments should not be taken as limiting the scope of the invention, which is defined by the appending claims.

1. A method for managing a system configuration of a robot controller configured to control operation of a robot, the method comprising:
capturing a snapshot of the robot controller, the snapshot including a current system configuration of the robot controller,
storing the captured snapshot in a backup archive configured to store a plurality of snapshots,
generating, on a display, a graphical user interface including elements representing one or more snapshots stored in the backup archive presented in chronological order,
and upon receiving, from an input device, user input selecting one of the displayed elements,
retrieving, from the backup archive information corresponding to the snapshot represented by the selected element, and
providing the retrieved system configuration.

2. The method of claim 1 further comprising:
installing an initial system configuration and storing a snapshot including the initial system configuration in the backup archive.

3. The method of claim 1, wherein the capturing and the storing are repeated upon reception of user input, in response to predefined triggers and/or on a periodical basis.

4. The method according to claim 1, comprising capturing and storing snapshots representing distinct systems of a multiple system configuration of the robot.

5. The method according to claim 1, wherein the generating comprises displaying the elements along a timeline.

6. The method according to claim 1, wherein the snapshot comprises a snapshot identifier and wherein the generating includes displaying the snapshot identifier in connection with the corresponding displayed element.

7. The method according to claim 1, wherein the generating comprises displaying elements representing snapshots captured during a limited time period and moving the limited time period forwards or backwards in time in response to receiving a user input indicating scrolling.

8. The method according to claim 1, wherein the providing comprises at least one of:
installing the retrieved system configuration in the robot controller,
loading the retrieved system configuration on a data storage device,
sending the retrieved system configuration to another robot controller,
sending the retrieved system configuration to a remote device.

9. The method according claim 1, wherein the providing comprising presenting, in the graphical user interface, selectable elements representing provision alternatives.

10. The method according to claim 1, wherein the storing comprises storing the snapshot in a backup archive being a backup archive in the robot controller and/or in backup archive external to the robot controller.

11. The method according to claim 1, wherein the system configuration comprises at least one of operating system software, application software, user data, robot calibration data and/or robot configuration data.

12. A control system configured to manage a system configuration of a robot controller of a robot, wherein the control system is provided with access to a backup archive, the control system comprising:
at least one computing device having at least one processor and memory, the at least one computing device being configured to:
capture a snapshot including a current system configuration of the robot controller,
store the captured snapshot in a backup archive configured to store a plurality of snapshots,
generate, on a display, a graphical user interface including elements representing one or more snapshots stored in the backup archive presented in chronological order,
and upon receiving, from an input device, user input selecting one of the displayed elements,
retrieve, from the backup archive information corresponding to the snapshot represented by the selected element, and
provide the retrieved system configuration.

13. The control system of claim 12, wherein the computing device is configured to repeatedly capture and store snapshots upon reception of user input, in response to predefined triggers and/or on a periodical basis.

14. The control system claim 12, wherein the computing device is configured to display the elements along a timeline.

15. A system comprising:
a robot,
a displayer configured to display robot control information,
an input device configured to receive user input from a user,
a backup archive and
the control system according to claim 12.

16. The method of claim 2, wherein the capturing and the storing are repeated upon reception of user input, in response to predefined triggers and/or on a periodical basis.

17. The method according to claim 2, comprising capturing and storing snapshots representing distinct systems of a multiple system configuration of the robot.

18. The method according to claim 2, wherein the generating comprises displaying the elements along a timeline.

19. The method according to claim 2, wherein the snapshot comprises a snapshot identifier and wherein the generating includes displaying the snapshot identifier in connection with the corresponding displayed element.
